(19) United States
(12) Patent Application Publication
(10) Pub. No.: US 2010/0243280 A1
(43) Pub. Date: Sep. 30, 2010

(54) FIRE RETARDANT COMPOSITION AND METHOD

(76) Inventor: Rinoud Hanna, Rochester, NY (US)

Correspondence Address: LAW OFFICE OF TRACY P. JONG, 2775 BUFFALO ROAD, SUITE 3, ROCHESTER, NY, 14624, US

(21) Appl. No.: 12/794,342

(22) Filed: Jun. 4, 2010

Related U.S. Application Data
(63) Continuation-in-part of application No. 12/319,744, filed on Jan. 12, 2009.

(51) Int. Cl. A62C 2/00; C09K 21/02; A62D 1/00

(52) U.S. Cl. 169/46; 252/610; 252/2

(57) ABSTRACT

A method of controlling fire by using a composition that fuses glass in situ when exposed to flames. A fire retardant and extinguishing composition that fuses a glass layer when exposed to flames. The glass layer envelops a combustible material to delay or inhibit combustion of the combustible material, or to extinguish flames. The composition comprises an aqueous suspension of glass powder. The glass is preferably formed from oxides of silicon, aluminum, boron and combinations thereof.

### RELATED APPLICATIONS AND PRIORITY CLAIM

This continuation-in-part application claims priority to U.S. Ser. No. 12/319,744 filed Jan. 12, 2009. This application is incorporated by reference herein in its entirety.

### FIELD OF THE INVENTION

This application generally relates to fire retardant compositions and methods, and more particularly, to a fire retardant composition that fuses a glass layer in situ upon exposure to heat energy of a fire that envelops a combustible material to inhibit combustion of the combustible material. There is also disclosed a method for suppressing fires using such composition.

### BACKGROUND OF THE INVENTION

Fire retardants are used either to extinguish fires directly or to form a fire front to contain a burning zone and to prevent it from spreading. Such retardants typically contain compounds of various elements including phosphorus, sulfur, lead, chlorine, bromine, boron and nitrogen. While halogen containing compounds are effective for neutralizing gases needed to sustain fire, such compounds are often toxic or harmful to the environment. Compounds containing boron, sulfur and phosphorus, such borates, sulfates and phosphates, are also effective fire suppressants but are often toxic in nature or otherwise harmful to the environment. U.S. Pat. No. 4,197,913 (Korenowski) and U.S. Pat. No. 4,272,313 (Vandersall) describe various such suppressants and retardants containing such compounds. U.S. Pat. No. 3,367,863 to Cooper teaches a fire extinguishing composition comprising an aqueous slurry/suspension of borax. Cooper's composition contains phosphate, a compound known to have an adverse environmental impact. In U.S. Pat. No. 3,633,675, Biederman teaches a slurry consisting of clay, float ash and phosphate that form a foam that is sprayed on flammable objects. Phosphates promote the growth of algae in ponds and streams, dangerously harming the fish population. Korenowski teaches a slurry that also comprises clay and gypsum. Gypsum, however, is harmful to the environment, especially birds.

The teachings of the Korenowski prior art are directed at the use of clays (kaolin and bentonites (montomorillonite)) to suspend particulates in a slurry. While bentonites (montomorillonite) contain aluminum, it is part of the crystalline structure and is not functioning as the active fire retarding component. Further, the aluminum is bound in the structure of the clay and does not have any role in suppressing fires; it is just coincidentally is present in the clay. The Korenowski and Beiderman subject matter comprise an aluminum that will not form the glassy phase required for a fire prevention composition with the advantages and properties of the present invention.

The previous discussion reveals many shortcomings associated with the prior art fire suppression and retardants. The purpose of the present invention is to overcome several of the shortcomings affiliated with the prior art as well as the introduction of additional novel features.

It is an object of the present invention to provide a composition and method for retarding, suppressing and extinguishing fire with the use of a glass or glassy thin film layer over the combustible material.

It is an object of the present invention to provide a nontoxic environmentally safe fire retardant that can be used indoors or outdoors.

It is therefore an object of this invention to provide a fire retardant composition which has minimal effect on the environment.

It is a further object of this invention to provide a fire retardant composition which efficiently reduces or eliminates the spreading of fires, especially shrubbery, brush and forest fires.

It is yet another object of this invention to provide a fire retardant composition which is convenient to transport and use.

Whereas there may be many embodiments of the present invention, each embodiment may meet one or more of the foregoing recited objects in any combination. It is not intended that each embodiment will necessarily meet each objective.

### SUMMARY OF THE INVENTION

These and other objects are accomplished with a novel fire retardant composition that fuses a glass barrier on the surface to which it is applied thereby shielding the surface from fire. The present invention relates to a fire retardant composition that fuses a glass layer in situ when exposed to the heat energy of flames. The glass, preferably formed of metal oxides of aluminum and/or boron and/or silicon, envelops a combustible material to inhibit or delay its combustion and provide an oxygen barrier. In one embodiment of the glass powder, aluminum oxide or boron oxide is combined with a sufficient amount of silicon dioxide/oxide to form an aluminosilicate or borosilicate glass when exposed to fire. In another embodiment, the novel composition comprises an aqueous suspension of glass powder containing each aluminum oxide and boron oxide that forms a CABAL glass material when exposed to flames. The glass powder is combined with a cooperating carrier to provide a means for delivery. An aqueous suspension of glass powder is a typical embodiment. The fire retardant composition is conveniently applied as a spray and other suitable type of coating to the area to be protected. It is particularly effective when applied to areas of vegetation such as forests, brush, or to surfaces of building structures. Due to its absence of phosphates, sulfates, and gypsum, the composition of this invention is environmentally friendly.

Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification and claims appended hereto.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the conception regarded as the present invention.

### PARTICULAR ADVANTAGES OF THE INVENTION

The present invention provides several advantages. This novel suspension of a multi-component glass fuses a glass or glassy thin film layer upon exposure to the heat energy of flames that has superior fire retardant qualities. The glass is formed from metal oxides, and especially oxides of silicon, aluminum and boron, When exposed to fire, the fire retardant composition emits no toxic gases, only water vapor. The boron oxide loses its identity in the glass network, therefore obviating concerns of boron toxicity. The present invention is free of undesirable phosphate, gypsum and sulfates and thus can be used on vegetation without presenting environmental concerns. Natural precipitation or the application of water effectively removes the fire retardant composition from trees, shrubs and grasses following application and use. The suspension may be used indoors and outdoors and is relatively inexpensive.

### DRAWINGS

FIG. 1 is a plan view of a fire tray used to simulate brush fire conditions in Example 4.

### DETAILED DESCRIPTION OF A PREFERRED EMBODIMENT OF THE INVENTION

This invention is based on Applicant's discovery of a fire retardant and fire extinguishing agent containing glass powder that can be pumped, poured or sprayed on burning surfaces and is converted by the heat of the fire to fuse a glass or glassy thin film layer or coating that extinguishes the burning and prevents reigniting. A glass and a cooperating carrier are combined to provide an effect means of delivery. The glass is typically in the form of glass powder and suspended in liquid. Coating over the combustible material or vegetative area with this liquid mixture will generally conform to the topography; that is, fully coating cracks and deep crevices. When exposed to heat energy (e.g., fire or flames), a glass or glassy thin film fuses and the fire is retarded, extinguished and/or prevented from reigniting by the coating. The adherent glass coating provides an oxygen barrier that induces oxygen starvation and inhibiting combustion. The emission of water vapor also contributes to the fire retarding properties of the composition. Since this fire retardant and extinguishing agent can be applied like water to reach fires in remote crevices, it is especially useful for the outdoor environs and the treatment of brush, forest and shrubbery fires. The glass may be formed with one, two or three network formers. Preferably the metal oxides of silicon, boron and aluminum are used as network formers either singly or in combination. Other preferred metal oxides include titanium and zirconium.

This novel combination of glass (formed of the oxides of aluminum and/or silicon and/or and boron) has superior fire retardant properties. When the novel suspension of glass is exposed to heat energy from the flames, a glass or glassy thin film layer is fused in situ that envelops a combustible material to inhibit or delay the combustion of the combustible material. This novel composition emits no gases but only water vapor when exposed to flames, thus providing an environmentally safe fire extinguish and/or retardant.

Spraying a suspension of glass powder on the brush or trees in forests, for example, is similar to enameling metals in industry for corrosion protection and the like. In such application, the glass is applied in the form of a paint and then melted or fused onto the metal. Another method of application is to spray a suspension of the glass powder onto the metal and subsequently fire it in a high temperature furnace to produce an even and continuous glass coating or layer on the metal. This method is used, for example, in corrosion protection of cast iron and steel metal sheets. A. I. Andrews, Porcelain Enamels, The Garrard Press Publishers, Champaign, Ill.

In the case of sprayed vegetation, the flames themselves (of the fire which has to be contained or stopped) will provide the heat energy to fuse the sprayed suspension of glass powder to form in situ a glass or thin glassy film layer on the surface of the vegetation. This will prevent the fire from advancing and prevent oxygen from reaching the material or vegetation substrate under the glass layer barrier. (Test 3 described below will best demonstrate this principle.)

As will be apparent to those skilled in the art, the glasses which would be suitably used to spray forests and vegetation for fire control will have different physical characteristics from those used in metal enameling processes. Preferably, glasses used for fire control have lower fusing temperatures than those used in metal enameling. In one aspect, fusing temperatures less than 1400 degrees Fahrenheit are preferred. As will also be recognized, mill additions such as opacificers, colors and the like are not necessary. The glass should have good adherence, fluidity, and wetting (small contact angle) properties. Materials costs and safety/toxicity should also be taken into account when selecting glass to use in the glass powder for the suspension. The examples described below show modifications in the glass properties by changing relative percentages of various oxides with respect to one another and by using various combinations of one to three oxides as the glass network formers.

A novel method of controlling fire (inhibiting, retarding and/or extinguishing fire) uses an aqueous suspension of glass powder sprayed on combustible material such as trees or vegetation. When the flames reach the area treated with this glass powder suspension, the glass powder fuses to form a solid glass. This creates a wall that contains the fire. By way of illustration, a narrow strip of forest may be treated with the aqueous suspension of glass powder in advance of an incoming fire. When the fire reaches the strip that has been treated, solid glass or a glassy thin film will form on the trees and ground and prevent further advancement of the fire. Only minimal damage to the trees and vegetation will have occurred. After the fire, water or precipitation will wash away the glass and unused suspension materials. By way of further illustration, in an urban area, a narrow strip of lawn or shrubbery, or even the exterior façade of a structure, may be treated with the aqueous suspension of glass powder in advance of an incoming fire. When the fire reaches the strip that has been treated, solid glass or a glassy thin film will form on the lawn, structure and/or ground and prevent further advancement of the fire. Only minimal damage to the structure and vegetation will have occurred.

A glass is an amorphous (non-crystalline) solid material. Glasses are an inorganic product of fusion which has been cooled through its glass transition to the solid state without crystallizing. Glass transition or vitrification refers to the transformation of a glass-forming liquid into a glass, which usually occurs upon rapid cooling. It is a dynamic phenomenon occurring between two distinct states of matter (liquid and glass), each with different physical properties. Upon cooling through the temperature range of glass transition (a “glass transformation range”), without forming any long-range order or significant symmetry of atomic arrangement, the liquid contracts more continuously at about the same rate as above the melting point until there is a decrease in the thermal expansion coefficient. The glass transition temperature, T_{g}, is lower than melting temperature, Tₘ, due to super cooling.

Glasses contain one or more glass network formers that form its primary building block. Oxides are preferably used as network formers in the present composition. In one embodiment, the extinguishing agent of this invention is a combination of network formers that form a glass by an in situ reaction of a liquid suspension mixture of an aluminum oxide and a boron oxide source material in the presence of flame. Suitable boron oxide sources include boric oxide, boric acids, metal tetraborates and metal metaborates, any of which may be used with equal efficacy in situ. Suitable aluminum sources include aluminum oxides and acids, metal tetraaluminates and metal metaaluminates, any of which may be used with equal efficacy in situ. Silicon oxides are also advantageously used in the novel composition. Any single oxide may be used as a network former (and especially an oxide of aluminum, boron, silicon, titanium or zirconium), or a combination of two oxides of (especially an oxide of aluminum, boron, and silicon). Most preferably, oxides of all three (aluminum, boron and silicon) are used as glass network formers. Over long storage, the dispersed solids may settle out slightly, but they do not agglomerate and are very readily redispersed in slight agitation. The amount of water may be widely adjusted to modify the viscosity of the extinguishant.

As will be well known in the art, glasses are formed from oxides of certain elements, such as silicon, boron and aluminum. Each oxide loses its individual identity within the glass. Lawrence H. Van Vlack, Physical Ceramics for Engineers, The University of Michigan, (1960). Most glasses contain more than one oxide component. In one embodiment, the combination of glass network formers form a glass layer comprised of tetrahedral coordination units of silicon dioxide, boron oxide, aluminum oxide or combinations of these oxides. The majority of glasses utilize a network of SiO₄ tetrahedral as the basis of their structure. The tetrahedron shape is seen in nature in covalent bonds of molecules. All sp³-hybridized atoms are surrounded by atoms lying in each corner of a tetrahedron. Silica glass is a common glass of a single oxide forming the SiO₄ tetrahedral to produce a 3-dimensional network.

Preferably the glass network formers comprise from about 2% to about 35% by weight of the novel composition.

In one embodiment, the glass contains oxides of boron and aluminum that will form a glass composed of triangular coordination units of silicon dioxide, boron oxide, aluminum oxide or combinations thereof.

In one embodiment, the glass formed comprises a borosilicate or an aluminosilicate with two network formers—the silicon in combination with either boron or aluminum. Other appropriate network formers may be substituted and will be well known in the art.

In one embodiment, the glass formed is a CABAL calcium boroaluminate glass formed of two network formers—boron oxide and aluminum oxide.

In one embodiment, the glass formed comprises three network formers—the silicon, boron and aluminum. Other appropriate network formers may be substituted and will be well known in the art.

In one embodiment, the glass formed comprises a single network former—the silicon, boron or aluminum. For example, the glass layer may be a borate glass or silicate glass. Other appropriate network formers may be substituted and will be well known in the art.

These network formers form a highly crosslinked network of chemical bonds. In the present invention, the preferred network formers include silicon, boron and aluminum. Other network formers that may be used in addition include germanium, titanium, zirconium, beryllium, magnesium, and zinc. Modifiers (calcium, lead, lithium, sodium, and potassium) may be incorporated in the composition to alter the network structure; they are usually present as ions, compensated by nearby non-bridging oxygen atoms, bound by one covalent bond to the glass network and holding one negative charge to compensate for the positive ion nearby. Some elements can play multiple roles; e.g. lead can act both as a network former (Pb⁴⁺ replacing Si⁴⁺), or as a modifier.

Applicant's boron and aluminum combination forms a glass network that has fire prevention properties. Aluminum and boron are used in the present invention because of their physical characteristics such as quick fusion, adherence, fluidity, and wetting (i.e. small contact angle). In addition, aluminum and boron take into account material costs and safety to people and environment. The use of aluminum in the inventive composition is particularly suitable since it is the third most abundant element of the earth's crust. In addition to its presence in clays, minerals and rocks, it is also present in natural water as a soluble salt, as well as in colloidal and insoluble compound forms (L. S. Clesceri, A. E. Greenberg and R. R. Trussell, “Standard Methods for the Examination of Water and Waste Water,” 1989, 17^{th} Edition, pp 3-63).

Boron is also used in some embodiments of the novel composition. It has been discovered that compositions of aluminum and boron produce some of the best fire retarding properties. Boron has been identified as a hazardous substance, however, when the glass is formed, it loses its individual properties and thus boron loses its toxicity when combined with aluminum to form glass. Thus, Applicant's disclosure teaches a novel combination of aluminum and boron that has superior fire retardant qualities and the unexpected result of nontoxicity when the two are combined.

In one embodiment, the fire retardant composition also contains one or more of the following elements: gallium, silicon, scandium, yttrium, lanthanum, actinium, lutetium, lawrencium and combinations thereof.

In one embodiment, the fire retardant composition also contains one or more of the following elements: of titanium, zirconium, hafnium and rutherfordium. (Titanium and zirconium are the most cost effective.)

In one embodiment, the fire retardant composition comprises from about 2% to about 35% by weight of glass network former where from about 7% to about 34% by weight is aluminum. In one aspect, it further comprises from about 2% to about 28% by weight boron.

Thus, there is also provided a method of suppressing fires by applying an effective amount the fire retardant composition to form a glass or glassy thin film barrier to retard, extinguish or suppress a fire. Preferably, the fire retardant composition comprises an aqueous suspension of glass powder of a glass formed from the oxides of silicon, aluminum, boron and combinations thereof. Preferably, the glass network formers in the composition comprise from about 2% to about 35% by weight of the fire retardant composition. In one aspect, the fire retardant composition is applied to a surface of a building structure when the building structure is burning. It may be used in the same manner as a conventional fire extinguishant. In another aspect, the fire retardant composition is applied to a surface of a building structure before the building structure is burning. In another aspect, the fire retardant composition is applied to vegetation, wooded area or brush when burning. In another aspect, the fire retardant composition is applied to vegetation, wooded area or brush before burning to prevent the spread of fire or to contain the approaching fire.

The following examples are provided to further illustrate the present invention. Several glasses were tested and their composition was changed in order to find one which provided the optimum glass layer on vegetation (or other combustible substrates) and thus could be used as an effective fire retardant. By changing the concentration of some or all the glass network former components, its structure was altered. Various combinations of three glass network formers were tested. Glasses with only two components such as borosilicates and aluminosilicates were also tested. Glasses with only a single network former were tested. Applicant contends that this novel combination of aluminum and boron was not anticipated or obvious but rather the result of research and experimentation over a period of years. The initial testing was carried out by placing the suspension of the glass on small stainless steel plate. After drying under an infrared lamp, it was heated at high temperatures. If the resulting glass layer that formed was satisfactory, it was subjected to the following tests:

### EXAMPLES 1, 2, and 3

The series of tests in these examples demonstrate the fire retardant properties of the composition of this invention. East test uses a wooden stick having a length of approximately 11 inches and a cross section of approximately 0.014 square inches. In each of examples 1A, 1B and 1C, a dry or blank untreated stick is secured at one end with a clamp. A candle is placed at the other (or unclamped) end of the stick. The stick is then placed inside the flame of the candle in such a manner that the distance between the center of the flame and the unclamped end of the stick is always constant at 3 inches. In each of examples 2A, 2B, and 2C, a wooden stick is soaked in water for one hour, clamped at one end and positioned in the same manner as described above. In each of examples 3A, 3B, and 3C, a wooden stick is coated with the aqueous suspension fire retardant composition of this invention at a concentration of 63%, clamped at one end and position in the manner as described above. When the stick is inside the cabled flame, it starts to burn. This burning is accompanied by its twisting and bending downwards until it finally breaks away from the clamped part of the stick. In other words, the broken piece is the 3 inches part of the stick. The burn time is measured from the moment the stick enters the flame until the 3 inches part starts to bend downwards. The results of these tests are set forth in Table 1 below.

TABLE 1

| | Stick | Burn Time | |
|---|---|---|---|
| Example | Treatment | (seconds) | Observation |
| 1A | None | 10.35 | Flame advanced horizontally |
| 1B | None | 10.1 | along the wood on both sides of |
| 1C | None | 12.0 | the candle flame burning the wood |
| | | | in its path. |
| 2A | Water | 30.0 | Flame advanced horizontally but |
| 2B | Water | 29.5 | to a lesser extent than the dry |
| 2C | Water | 32.0 | blank in Examples 1A, 1B, and |
| | | | 1C. |
| 3A | Coated | 701.6 | Burning is confined to the part of |
| 3B | Coated | 687.2 | the stick within the candle flame, |
| 3C | Coated | 526.7 | i.e. the flame did not advance |
| | | | horizontally along the wood as it |
| | | | did in Example 1A, 1B, and 1C |

### Example 4

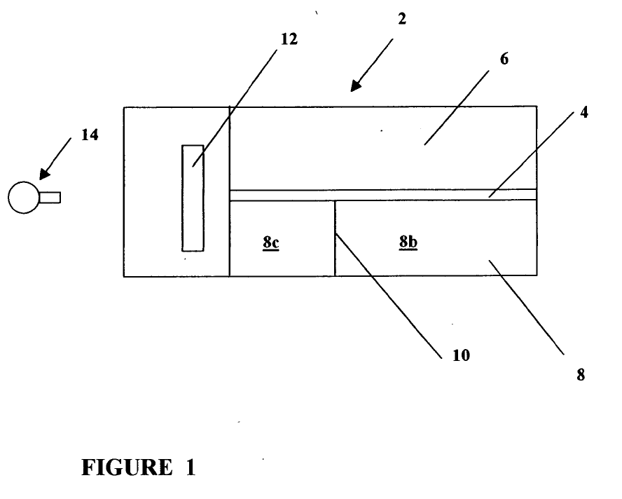

The purpose of this example is to demonstrate the effectiveness of the fire retardant composition of this invention when used in simulated brush fire conditions. Test tray 2, as shown in FIG. 1, is used to create simulated brush fire conditions. Test tray 2 is made of iron and has a perimeter which is about one inch in height. It is divided into region 6 and region 8 by metal barrier 4 which is positioned so that it is perpendicular to the end of the tray. Region 8 contained a second barrier 10 which is perpendicular to barrier 4 extends from barrier 4 to the side of tray 2 and subdivides region 8 into region 8b and region 8c. Fire through 23 is situated adjacent to region 6 and region 8c. The dimensions of the tray are approximately 12 inches by 30 inches, the dimensions of the regions 6 and 8 are about 6 inches by 24 inches band the dimensions of regions 8b and 8c are about 6 inches by 18 inches by 6 inches, respectively.

In this example, regions 6, 8b, and 8c are cove red with a layer of standard garden mulch. Approximately 10 cc of the fire retardant composition used in Examples 3A, 3B, and 3C is sprinkled on the much, in region 8c only. Fire trough 122 is packed with ignitable tree bark and is periodically supplied with a mixture of gasoline and alcohol. The combustible bark is ignited and immediately forms a wall of flames. A stream of air, such as that provided by hand blower 14, simultaneously directs the wall of flames toward the mulch in regions 6 and 8c. The mulch in region 6 becomes ignited and gradually is advanced by the stream of air toward the appropriate end of tray 2 until all of the mulch in region 6 is completely burned. During this period, the mulch is regions 8b and 8c do not ignite and catch fire. The mulch in region 8c, which has been treated with the composition of this invention, forms a protective belt which prevents flame from reaching the mulch in region 8b.

In this example, the mulch simulated brush and the air stream provided by blower 14 stimulates wind. The mulch in region 8c treated with the fire retardant composition of this invention simulated an area of brush or wooded area that is similarly treated. The example thus demonstrates the effectiveness of the fire retardant composition in controlling the spread of brush fires and particularly those whose flames are accelerated by windy conditions.

The invention has been described in detail with particular reference to certain preferred embodiments thereof, but it will be understood that variations and modifications can be effected within the spirit and scope of the invention.

I claim:

1. A fire retardant composition that fuses a glass layer when exposed to heat energy, wherein the glass layer substantially shields a combustible material from available oxygen, inducing oxygen starvation, thereby inhibiting combustion of the combustible material, the fire retardant composition comprising:
a glass powder, and
a carrier that suspends the glass powder thereby providing a means for
the fire retardant composition delivery.

2. The fire retardant composition of claim 1 wherein the glass comprises a glass formed from a metal oxide selected from the group consisting of silicon dioxide, aluminum oxide, boron oxide and combinations thereof.

3. The fire retardant composition of claim 2 wherein the metal oxide comprises aluminum oxide and boron oxide.

4. The fire retardant composition of claim 3 wherein the metal oxide further comprises silicon dioxide.

5. The fire retardant composition of claim 1 wherein the metal oxide comprises titanium oxide or zirconium oxide.

6. The fire retardant composition of claim 2 wherein the glass layer formed comprises a CABAL calcium boroaluminate glass.

7. The fire retardant composition of claim 2 wherein the glass layer formed comprises a silicate glass or a borate glass.

8. The fire retardant composition of claim 2 wherein the glass layer formed comprises a borosilicate or an aluminosilicate glass.

9. The fire retardant composition of claim 1 wherein the fire retardant composition comprises from about 2% to about 35% by weight of a glass network former.

10. A fire extinguishing composition for applying to a fire, comprising: an aqueous suspension of glass powder that forms a glass when contacted by said fire.

11. The fire extinguishing composition of claim 10 wherein the glass powder comprises at least one metal oxide selected from the group consisting of silicon dioxide, aluminum oxide, boron oxide and combinations thereof.

12. A method of suppressing fires comprising the step of applying an effective amount the fire retardant composition of claim 1 to a combustible material to suppress a fire.

13. The method of claim 12 wherein the glass comprises a glass formed from a metal oxide selected from the group consisting of silicon dioxide, aluminum oxide, boron oxide and combinations thereof.

14. The method of claim 13 wherein the fire retardant composition is applied to a surface of a building structure when the building structure is burning.

15. The method of claim 13 wherein the fire retardant composition is applied to a surface of a building structure before the building structure is burning.

16. The method of claim 13 wherein the fire retardant composition is applied to vegetation, wooded area or brush when burning.

17. The method of claim 13 wherein the fire retardant composition is applied to vegetation, wooded area or brush before burning to prevent the spread of fire.
